(19) United States
(12) Patent Application Publication
(10) Pub. No.: US 2013/0120429 A1
(43) Pub. Date: May 16, 2013

(54) METHOD OF REPRESENTING EMOTION IN A TEXT MESSAGE

(71) Applicant: Nickolas S. Sukup, Clear Lake, IA (US)

(72) Inventor: Nickolas S. Sukup, Clear Lake, IA (US)

(21) Appl. No.: 13/298,050

(22) Filed: Nov. 16, 2011

(51) Int. Cl. G09G 5/02; G09G 5/00

(52) U.S. Cl. 345/589; 345/619

(57) ABSTRACT

A method of representing an emotion in a text message. The method includes providing a mobile system that has a display and operating system with a short message service. The operating system receives a text message and reviews the text message with a text application that is integrated into the software of the short message service. The text application then detects a series of characters that are provided in the text message and alters the text to indicate the emotion associated with the series of characters that has been detected.

### BACKGROUND OF THE INVENTION

This invention relates to text messaging. More specifically this invention relates to presenting font associated with a series of characters so that emotion can be detected in a text message.

As technology evolves new ways of communicating with one another are constantly presented. Over the last several years text messaging has become a very popular form of communication between individuals. So much so that individuals that text often have created their own language including phrases like “OMG” or “LOL” in order to increase the speed at which people can communicate with one another.

Such technology allows individuals to communicate more readily with others strengthening relationships through shared experiences such as texting when one is viewing a certain sporting event or experience. Though many advantages from communicating in this manner have been presented such communication does have its defaults. For example, emotion from a text message is very difficult to perceive. Thus, individuals using sarcasm or presenting information that's intended to be in a joking tone is often misinterpreted. This can result in hurt feelings, strains on friendships, and awkward social situations.

An attempt to address this issue, texters have developed emoticons that started as typed symbols presented at the end of sentences that attempted to show the emotion associated with the sentence previously stated. For example, a “:)” indicates that an individual is happy as a result of the information they have just provided. In order to enhance this, software applications have been presented that will detect emoticons as they are presented in a text message or an e-mail and convert them to a cartoon emoticon such as an actual smiley face, a face with an unhappy expression, and the like. Thus again the sender can attempt to show the emotion they are having regarding a statement or communication based upon the type of emoticons used.

Another manner in which emotion is attempted to be presented is through the use of different fonts and coloring of text. For example, a blue font often will present a sarcastic statement.

Despite these attempts by senders to show their intended emotion in sentences that are either texted or e-mailed to others, problems still remain. For example, individuals receiving text can still be confused and misinterpret the emoticons. Further, placing a text in certain font is time consuming depending on the amount of emotions presented in a text message or e-mail. Additionally, remembering which color of font represents sarcasm versus anger or happiness for different individuals can be difficult. Thus, a need in the art exists for representing the emotion of text messages.

Thus, a principal object of the present invention is to provide a method of representing emotion in a text message.

Yet another object is to provide an efficient manner of showing emotion in a text message.

These and other objects, features and advantages will become apparent from the specification and claims.

### BRIEF SUMMARY OF THE INVENTION

A method of representing emotion in a text message that includes providing a mobile system having a display and an operating system with a short message service. The operating system then receives a text message from a sender and reviews the text message with a text application integrated in the software of the short message service. The text application then detects a series of characters such as emoticons within the text message such that when the text message is displayed on the display screen text associated with that emoticon is altered either to provide a different colored font, size, or otherwise that is associated with an emoticon that is detected.

### BRIEF DESCRIPTION OF THE DRAWINGS

FIG. 1 is a front plan view of a mobile system;

FIG. 2 is a schematic view of text being displayed on a mobile device; and

FIG. 3 is a flow diagram showing a method of representing emotion in a text message.

### DETAILED DESCRIPTION OF THE PREFERRED EMBODIMENT

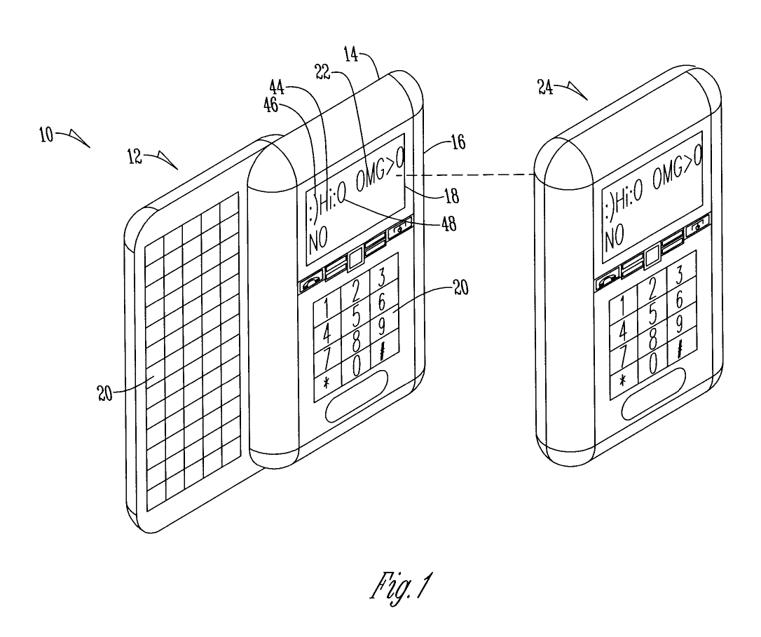

FIG. 1 shows a mobile system 10 that includes a mobile device 12 such as a cell phone, mobile phone, smart phone, PDA, Blackberry, handheld communication device, or the like. The mobile device 12 has a housing 14 that includes a power source 16 and an integrated display 18 that in a preferred embodiment is a screen. Electrically connected to the display 18 are a plurality of inputs 20 that can include numbers, letters, a keyboard, on and off buttons, mouse pads, and the like that are known in the art to allow an individual to input information such as a text message 22 into the mobile device 12 to be displayed on the display 18 and sent to a second remote mobile device 24.

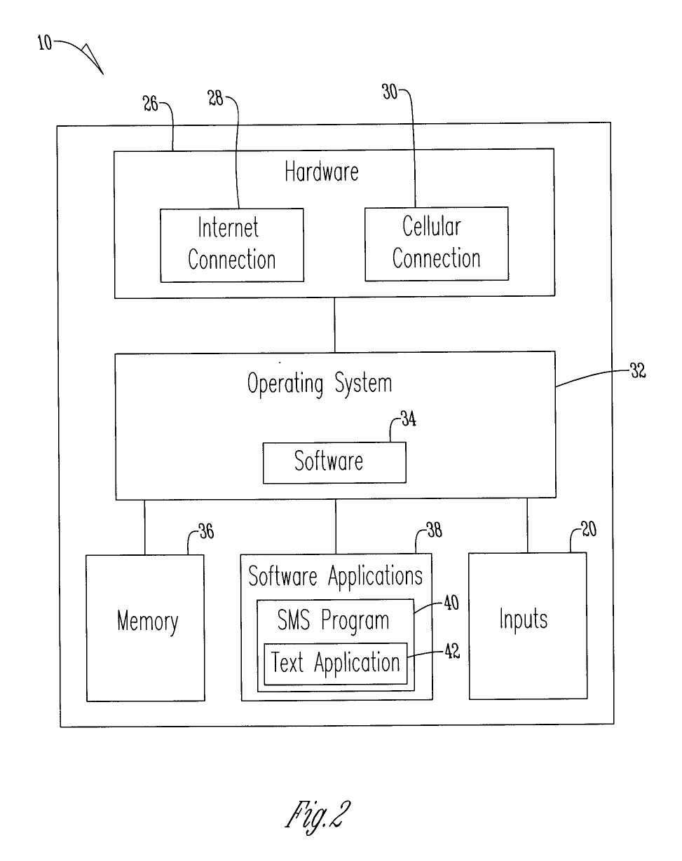

As best shown in the schematic diagram of FIG. 2 the mobile system contains hardware 26 including connections to the internet and cellular over the air communication 28 and 30. An operating system 32 communicates and operates the hardware and includes software 34 and is electrically in communication with mobile system memory 36, software applications 38 and inputs 20 in order to operate the mobile device 12.

The software applications 38 can include an SMS (short message service) program 40 that is used to prepare and send text messages. Integrated into the SMS program 40 is a text application 42.

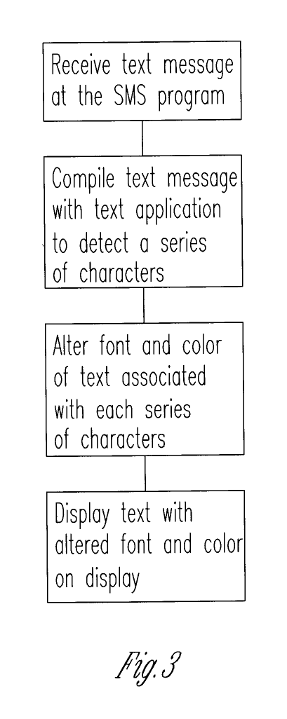

The text application 42 as best shown in FIG. 3 reviews the text 44 of all text messages received by the mobile device 12. The text application 42 then is programmed to recognize, identify and detect a series of characters such as emoticons 46 and 48 that are presented in the text message. While emotions 46 and 48 are preferably the series of characters series of characters can be an individual's name, a predetermined word or phrase, or the like.

Upon detecting a series of characters such as emoticon 46 or 48 in a text message the text application 42 then alters text 44 font associated with that emoticon 46 or 48. For example, the text 44 received can be changed to the font and color to represent the emotion 46 or 48 intended. Thus, either all the text 44 in front or behind an emoticon 46 or 48 up to the beginning or end of a next emoticon 46 or 48 or identifier would automatically be presented in a certain font. So, :)Hi :O OMG >O NO the “Hi” would be in a color of font for happy, the “OMG” would be presented as a surprise color and font and the “NO” would be presented in a mad color and font.

In operation an individual having a mobile system 10 receives a text message from a remote mobile device 24. The text application 42 reviews the text message to determine if any emoticons 46 or 48 are detected within the text 44. If emoticons 46 or 48 are detected in the text 44, the font either preceding or subsequent to the emoticon is turned a font and/or color associated with that emoticon 46 or 48. So, if a smiley face emoticon 46 is used a color such as orange can be used for the sentence preceding the emoticon 46 to indicate to a user that emotion associated with the emoticon 46 is happiness. Alternative, all the words subsequent to the emoticon 46 are in the orange font until another emoticon 48 is detected. When a second emoticon 48 is detected the font subsequent the emoticon 48 is altered to present a font or color associated with the second emoticon 48. Thus, the application 42 ends the previous color of the sentence to ensure an emotion has been changed. Thus, if the second emoticon 48 indicates anger, the font of the sentence subsequent to the emoticon 48 is red.

Thus provided is a mobile system 10 that utilizes a text application 42 in order to present different color of fonts in text 44 received by an individual. Thus, every text message an individual receives the individual is able to recognize the emotion of the information sent by the sender. Further, by having a program that utilizes different colors and fonts where every message is presented in these different fonts an individual begins to quickly recognize the emotion of the individual sending the text in the sentences provided. In addition, this is done automatically such that a sender does not have to present any type of special font themselves as the receiver of text will have the text application 42 that presents the proper font as is understood by the receiver of the message. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of representing emotion in a text. message steps comprising:
providing a mobile system having hardware, a display and an operating system with a short message service;
receiving a text message with the operating system;
reviewing the text message with a text application integrated in software of the short message service;
detecting a series of characters in the text message with the text application; and
displaying on the display the text message with altered text for text associated with the series of characters detected.

2. The method of claim 1 wherein the mobile system is a mobile phone.

3. The method of claim 1 wherein when an emoticon is detected as the series of characters the text subsequent the emoticon becomes a predetermined color associated with the emoticon.

4. The method of claim 3 wherein when a second emoticon is detected the text following the emoticon becomes a second predetermined color associated with the second emoticon.

5. A method of representing emotion in a typed message steps comprising
providing a mobile system having hardware, a display and an operating system with a message service;
receiving a typed message with the operating system;
reviewing the typed message with an application integrated in software of the message service;
detecting a series of characters in the typed message with the application; and
displaying on the display the typed message with altered text for text associated with the series of characters detected.

6. The method of claim 5 wherein the mobile system is a mobile phone.

7. The method of claim 5 wherein when an emoticon is detected. the series of characters of the text subsequent the emoticon becomes a predetermined color associated with the emoticon.

8. The method of claim 7 wherein when a second emoticon is detected the text following the second emoticon becomes a second predetermined color associated with the second emoticon.

9. The method of claim 5 wherein the typed message is an email.

10. The method of claim 5 wherein when an emoticon is detected the series of characters of the text subsequent the emoticon changes font associated with the emoticon.

11. The method of claim 5 wherein when an emoticon is detected the series of characters of the text subsequent the emoticon changes size associated with the emoticon.

12. The method of claim 5 wherein when an emoticon is detected the series of characters of the text subsequent the emoticon is italicized associated with the emoticon.

13. The method of claim 5 wherein when an emoticon is detected the series of characters of the text subsequent the emoticon is underlined associated with the emoticon.

14. The method of claim 5 further comprising the step of defining at least one series of characters as an emoticon.

15. The method of claim 5 further comprising the step of defining a response when an emoticon is detected.
